(19) United States
(12) Patent Application Publication
(10) Pub. No.: US 2026/0257385 A1
(43) Pub. Date: Sep. 3, 2026

(54) PERSONAL CARE APPARATUS

(71) Applicant: KONINKLIJKE PHILIPS N.V., EINDHOVEN (NL)

(72) Inventors: RONALD DE GROOT, RODEN (NL); WILLEM HENDERIKUS VELDHUIS, VEENDAM (NL)

(21) Appl. No.: 19/164,031

(22) PCT Filed: Feb. 28, 2024
(86) PCT No.: PCT/EP2024/055103

§ 371 Date: Sep. 10, 2025

(30) Foreign Application Priority Data
Mar. 10, 2023 (EP) 23161146.8

(51) Int. Cl. B26B 19/38; B26B 21/40

(52) U.S. Cl. CPC B26B 19/388; B26B 21/4056

(57) ABSTRACT

The subject-matter of the present disclosure relates to a personal care apparatus. The personal care apparatus comprises: a handle; a head at an end of the handle and having a connection portion for a device to connect to and disconnect from; an inertial measurement unit, IMU, sensor within the handle; and a controller. The controller is configured to: monitor measurements from the IMU sensor over time; compute one or more measurement values from the monitored measurements; identify a connection event or a disconnection event when the one or more measurement values fall within a classification boundary; and output the identified connection event or disconnection event as a signal.

### FIELD OF THE INVENTION

The subject-matter of the present disclosure relates to personal care apparatuses, such as shaving devices. More specifically, the subject-matter of the present disclosure relates to personal care apparatuses including a handle and an inertial measurement unit (IMU) in the handle.

### BACKGROUND OF THE INVENTION

US2019224869 describes a shaving appliance including a notification circuit for communicating cumulative shave event information. The shaving razor comprises a handle. A power source, an acceleration sensor, and an angular velocity sensor are positions in the handle. A razor cartridge displacement sensor is also positioned in the handle and measures a displacement of a razor cartridge relative to a fixed position of the handle. A new shaving cartridge event can be sensed by the displacement sensor.

It is an aim of the subject-matter of the present disclosure to improve on the prior art.

### SUMMARY OF THE INVENTION

According to a first aspect of the present invention, there is provided a personal care apparatus comprising: a handle; a head at an end of the handle and having a connection portion for a device to connect to and disconnect from; an inertial measurement unit, IMU, sensor within the handle; and a controller configured to: monitor measurements from the IMU sensor over time; compute one or more measurement values from the monitored measurements; identify a connection event or a disconnection event when the one or more measurement values fall within a classification boundary; and output the identified connection event or disconnection event as a signal, wherein the IMU comprises an accelerometer for measuring acceleration and a gyro for rotational velocity.

Advantageously, using the IMU sensor means that no additional sensors are required to detect connection and disconnection of the device from the head.

The gyro may be a gyroscope.

In an embodiment, the controller, when monitoring measurements from the IMU sensor over time, is configured to monitor acceleration and angular velocity from the IMU sensor in x, y, and z, axes, wherein optionally the x axis is a longitudinal axis of the body, and y and z axes are orthogonal to the x axis. In this way, the x, y, and z, axes may be mutually orthogonal, and may correspond to a cartesian coordinate system.

In an embodiment, the one or more measurement values includes a total acceleration and a total angular velocity, wherein the controller is configured to, when computing the one or more measurement values, calculate the total acceleration using the formula,

$${}_{} = \overline{{}_{} {}^{} + {}_{} {}^{} + {}_{} {}^{}}$$

and calculate the total rotation velocity using the formula

$${}_{} = \overline{{}_{} {}^{} + {}_{} {}^{} + {}_{} {}^{}} ,$$

where ⋅. is the total acceleration, ⋅. is an acceleration in the x-axis, ⋅. is an acceleration in the y-axis, ⋅. is an acceleration in the z-axis, ⋅. is the total rotational velocity, ⋅. is a rotational velocity in the x-axis, ⋅. is a rotational velocity in the y-axis, and ⋅. is a rotational velocity in the z-axis.

In an embodiment, the controller is configured to, when, identifying the connection event or the disconnection event when the one or more measurement values fall within the classification boundary, plot a standard deviation of the total acceleration and a standard deviation of the total rotational velocity on a scatter plot having one axis corresponding to standard deviation of total acceleration and another axis corresponding to standard deviation of total rotational velocity. Advantageously, this approach is more accurate than using the waveform directly.

In an embodiment, the controller is configured to, when monitoring measurements from the IMU sensor over time, construct a waveform from the measurements of the IMU sensor over time.

In an embodiment, the personal care apparatus further comprises a motor for powering the device, wherein the controller is configured to operate in a standby mode when the motor is not running. It is most likely that a user will have the apparatus in standby mode when changing the device. Therefore, operating the controller in standby mode avoids missing any replacements of the device. It should also be appreciated that this is an optional feature, and the control may operate when the motor is running, e.g. when the use is shaving in the event the personal care apparatus is a shaver.

In an embodiment, the connection portion is configured to deform in response to a connection formation of the device being inserted into it, the deformation being detectable by the IMU sensor.

In an embodiment, the connection portion includes a spring and the connection formation includes a protrusion, wherein the spring is configured to deform by compressing in response to the protrusion moving past the spring and to revert to its neutral position in response to the protrusion having moved past the spring, wherein the IMU sensor is configured to detect the spring reverting to its neutral position. The spring reverting to its neutral position may be associated with a vibration, which may emit a sound, e.g. a click.

In an embodiment, the protrusion is a first protrusion and the connection formation includes a second protrusion separated from the first protrusion by a notch, wherein the notch provides a weak point for the second protrusion to break off in response to disconnecting the device from the connection portion. Advantageously, breaking off the second protrusion means that the IMU measurements will be different for a new device and a device that has already been used and disconnected. This enables the controller to detect when a new device or a used device has been connected to the head.

In an embodiment, the personal care apparatus further comprising the device.

In an embodiment, the personal care apparatus is a shaver and the device comprises a blade.

According to an aspect of the present disclosure, there is provided a computer-implemented method of detecting a connection event in response to connecting a device to a connection portion of a head of a personal care apparatus, or detecting a disconnection event in response to disconnecting the device from the connection portion of the head of the personal care apparatus, the computer-implemented method comprising: monitoring measurements from an inertial measurement unit, IMU, sensor over time, the IMU sensor positioned within a handle of the personal care apparatus, the head at an end of the handle; computing one or more measurement values from the monitored measurements; identifying a connection event or a disconnection event when the one or more measurement values fall within a classification boundary; and outputting the identified connection event or disconnection event as a signal, wherein the IMU comprises an accelerometer for measuring acceleration and a gyro for rotational velocity.

According to an embodiment, there is provided a transitory, or non-transitory, computer-readable medium, having instructions stored thereon that, when executed by a processor, cause the processor to perform the computer-implemented method of the preceding aspect.

According to an example, there is provided a personal care apparatus comprising: a handle; a head at an end of the handle and having a connection portion for a device to connect to and disconnect from; an inertial measurement unit, IMU, sensor within the handle; and a controller configured to: monitor measurements from the IMU sensor over time; compute one or more measurement values from the monitored measurements; identify a connection event or a disconnection event when the one or more measurement values fall within a classification boundary; and output the identified connection event or disconnection event as a signal.

According to an example, there is provided a computer-implemented method of detecting a connection event in response to connecting a device to a connection portion of a head of a personal care apparatus, or detecting a disconnection event in response to disconnecting the device from the connection portion of the head of the personal care apparatus, the computer-implemented method comprising: monitoring measurements from an inertial measurement unit, IMU, sensor over time, the IMU sensor positioned within a handle of the personal care apparatus, the head at an end of the handle; computing one or more measurement values from the monitored measurements; identifying a connection event or a disconnection event when the one or more measurement values fall within a classification boundary; and outputting the identified connection event or disconnection event as a signal.

These and other aspects of the present invention will be apparent from and elucidated with reference to the embodiment(s) described hereinafter.

### BRIEF DESCRIPTION OF THE DRAWINGS

The embodiments of the present inventions may be best understood with reference to the accompanying figures, in which:

FIG. 1 shows a perspective view of a personal care apparatus and a removeable device being connected to a head of the personal care apparatus, according to an embodiment;

FIG. 2 shows a perspective view of the head of the personal care apparatus and the removeable device adjacent thereto, according to an embodiment;

FIG. 3 shows a cross-section view of a connection portion of the head of the personal care apparatus and a connection formation of the device inserted therein, according to an embodiment;

FIG. 4 shows a block diagram of components in a handle of the personal care apparatus, the components including an inertial measurement unit, IMU, and a controller, according to an embodiment;

FIG. 5 shows a time domain waveform of accelerations monitored by the IMU during a device connection event, according to an embodiment;

FIG. 6 shows a time domain waveform of angular velocities monitored by the IMU during the device connection event from FIG. 5, according to an embodiment;

FIG. 7 shows a time domain waveform of accelerations monitored by the IMU during a device disconnection event, according to an embodiment;

FIG. 8 shows a time domain waveform of angular velocities monitored by the IMU during the device disconnection event from FIG. 7, according to an embodiment;

FIG. 9 shows a scatter plot of standard deviations of total acceleration and angular velocity for a plurality of events, including a classifier boundary to separate other events from the device connection and disconnection events, according to an embodiment;

FIG. 10A shows a schematic view of a connection formation of the device from FIG. 2 before a disconnection event, according to an embodiment;

FIG. 10B shows a similar view as FIG. 10A of the connection formation after a disconnection event, according to an embodiment; and

FIG. 11 shows a flow chart summarising a computer-implemented method of detecting a connection event in response to connecting a device to a connection portion of a head of a personal care apparatus, or detecting a disconnection event in response to disconnecting the device from the connection portion of the head of the personal care apparatus, according to an embodiment.

### DETAILED DESCRIPTION OF THE EMBODIMENTS

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Personal care apparatuses, or personal care appliances, may involve grooming appliances, but also cleaning appliances, skin treatment appliances, hair removal appliances, massage devices, etc. Generally, personal care appliances perform a treatment or an operation to a human or animal body.

Hair cutting appliances and hair grooming appliances are well-known in the art and may comprise, for instance, shaves, trimmers, epilators, hair styling appliances, and combinations thereof. Typically, hair grooming appliances comprise an electric motor that is arranged to drive a cutting unit, for instance a blade set, so as to effect a hair cutting and/or grooming operation. More generally, hair cutting appliances may be also referred to as grooming appliances.

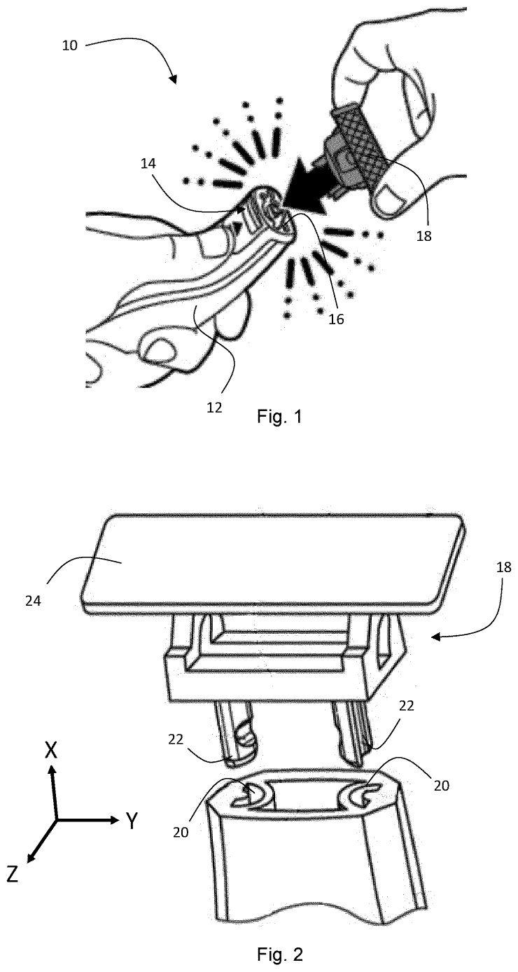

With reference to FIG. 1, a personal care apparatus 10 comprises a handle 12, a head 14 at an end of the handle. The head 14 has a connection portion 16 for a device 18 to be connected to and disconnected therefrom.

With reference to FIG. 2, the connection portion 16 comprises first and second slots 20. The device 18 comprises a connection formation. The connection formation comprises first and second posts 22. The first and second posts 22 have a complimentary cross-sectional shape with the first and second slots 20. In this way, the posts 22 may be inserted into the slots 20.

The device 18 includes a functional element 24, e.g. may be a shaver, or other grooming appliance listed above.

The handle 12 extends in an x-axis direction. In other words, the x-axis extends in line with a longitudinal axis of the handle 12. The y and z axes are orthogonal to the x axis. In this way, the x, y, and z, axes may be mutually orthogonal, and may correspond to a cartesian coordinate system.

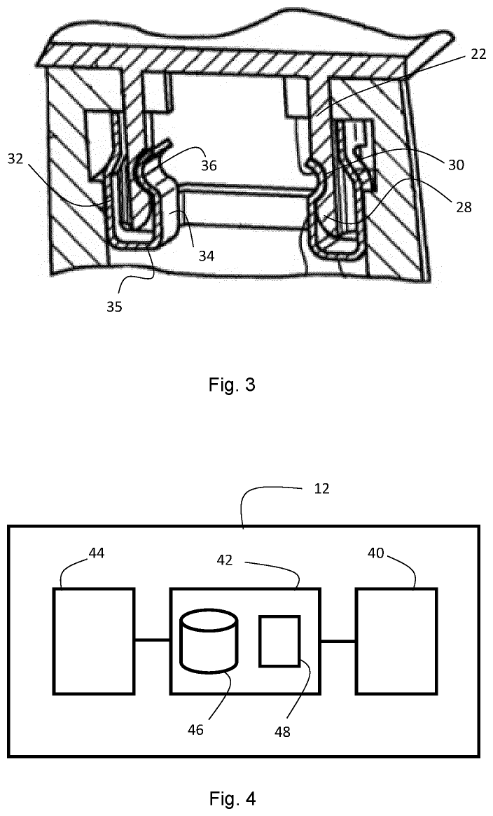

With reference to FIG. 3, the connection portion may include a spring 26. And the connection formation, or more specifically the posts 22, include a protrusion 28 and a recess 30. The spring may be a spring clip having two arms, a first arm 32 secured to an interior surface of the head 14 and a second arm 34 cantilevered from an elbow 35 between the first and second arms 34. The second arm comprises a protrusion 36 having a complimentary shape as the recess 30.

When the device is being connected to the handle, the second arms 34 deform elastically when the protrusion 36 passes of the protrusion 28 of the post 22. The second arm reverts to its neutral position when the protrusion 36 of the second arm 34 fits within the recess 30. This action may cause a vibration and a noise, e.g. a “click” sound, or the like. The opposite pattern occurs during a disconnection event.

In this way, the connection portion is configured to deform in response to a connection formation of the device being inserted into it, wherein the connection portion includes a spring, and the connection formation includes a protrusion, wherein the spring is configured to deform by compressing in response to the protrusion moving past the spring and to revert to its neutral position in response to the protrusion having moved past the spring.

With reference to FIG. 4, various components are positioned in the handle 12. The components include an inertial measurement unit (IMU) sensor 40, a controller 42, and a power supply 44.

The IMU 40 may comprise an accelerometer for measuring acceleration and a gyroscope, or gyro, for measuring rotational, or angular, velocity.

The controller 42 may include a processor 46 and storage 48. The storage may be a non-transitory computer-readable medium having instructions stored thereon that when executed by the processor 46, cause the processor 46 to perform any of the methods described herein. In other embodiments, the controller 42 may be part of an embedded system.

The controller is configured to monitor measurements from the IMU sensor 40 over time, computer one or more measurement values from the monitored measurements, identify a connection event or a disconnection event when the one or more measurement values fall within a classification boundary, and output the identified connection event or disconnection event as a signal. The signal may be a signal used within the controller to perform other functions. For example, when the controller is also used to monitor wear and predict replacement time of a device, the signal relating to a connection event can be used to start a timer, and the signal relating to a disconnection event can be used to reset the timer.

The power supply 44 may be a battery, either a primary battery or a secondary battery (or rechargeable battery). The power supply may also be a power cell. The power supply 44 may provide power to the controller 42 and the IMU sensor 40.

A motor (not shown) may also be provided in the handle to power the device. The motor may be powered by the power supply 44. The controller may be configured to operate in a standby mode when the motor is not running. The controller may also be configured to operate when not in standby more, i.e. when the motor is running.

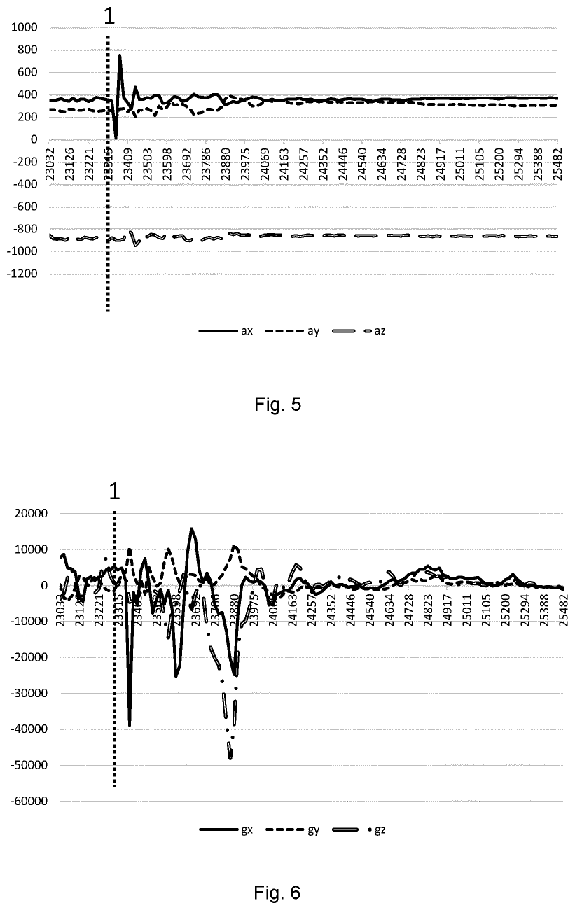

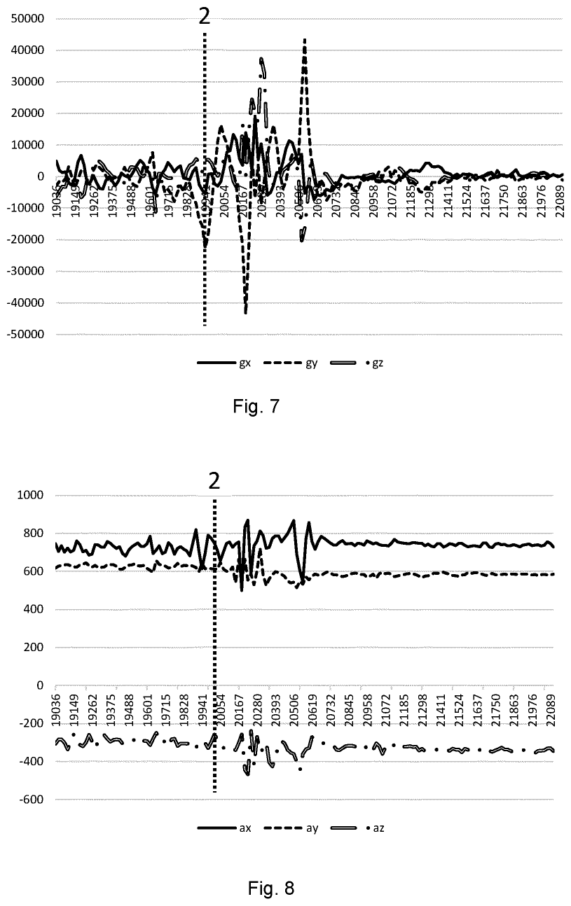

With reference to FIGS. 5 to 8, it can be seen that the controller, when monitoring measurements from the IMU sensor over time, is configured to monitor acceleration and angular velocity from the IMU sensor in the x, y, and z, axes. The measurements in each axis are shown separately as time domain waveforms in FIGS. 5 and 6 for acceleration and angular velocity, respectively. More specifically, FIGS. 5 and 7 each show a waveform of acceleration in the x-axis (ax), a waveform of acceleration in the y-axis (ay), and a waveform of acceleration in the z-axis (az). FIGS. 6 and 8 each show a waveform of angular velocity in the x-axis (gx), a waveform of angular velocity in the y-axis (gx), and a waveform of angular velocity in the z-axis (gz).

A broken line is overlayed to FIGS. 5 and 6 with reference 1, which indicates a start of a connection event.

Another broken line is overlayed to FIGS. 7 and 8 with reference 2, which indicates a start of a disconnection event.

It is the movement of the handle that is being detected by the IMU sensor. This includes movement by the user to manipulate the handle when connecting and disconnecting the device. This movement also include vibrations when the spring deforms, or deflects, and when it reverts to its neutral position. For instance, reverting to its neutral position may be associated with a sudden vibrational change, e.g. one associated with a noise such as a click sound.

The controller may be configured to, when monitoring measurements from the IMU sensor over time, construct the foregoing waveforms from the measurements of the IMU sensor over time.

In view of the operation of the controller outlined above, in some instances, the one or more measurement values includes a total acceleration and a total angular velocity. In this way, the controller is configured to, when computing the one or more measurement values, calculate the total acceleration using the formula,

$${}_{} = \overline{{}_{} {}^{} + {}_{} {}^{} + {}_{} {}^{}}$$

and calculate the total rotation velocity using the formula

$${}_{} = \overline{{}_{} {}^{} + {}_{} {}^{} + {}_{} {}^{}} ,$$

where ⋅. is the total acceleration, ⋅. is an acceleration in the x-axis, ⋅. is an acceleration in the y-axis, ⋅. is an acceleration in the z-axis, ⋅. is the total rotational velocity, ⋅. is a rotational velocity in the x-axis, ⋅. is a rotational velocity in the y-axis, and ⋅. is a rotational velocity in the z-axis.

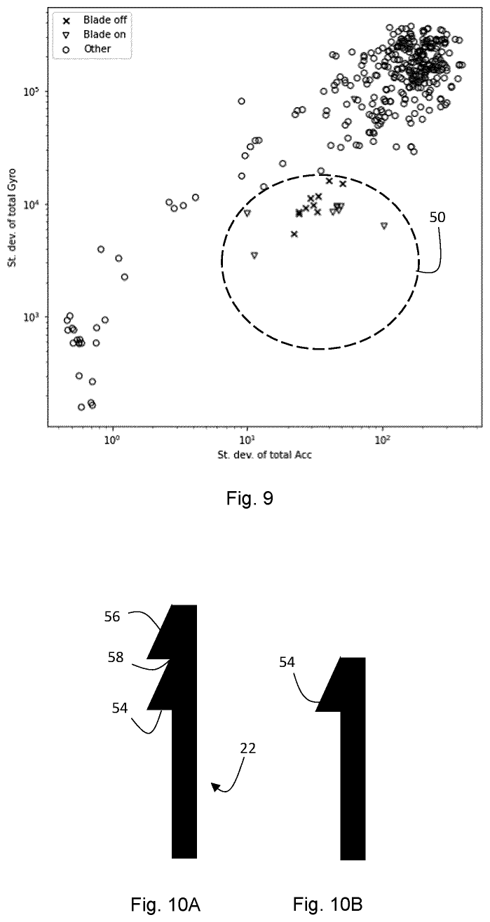

With reference to FIG. 9, the controller may be configured to, when, identifying the connection event or the disconnection event when the one or more measurement values fall within the classification boundary 50, plot a standard deviation of the total acceleration and a standard deviation of the total rotational velocity on a scatter plot having one axis corresponding to standard deviation of total acceleration and another axis corresponding to standard deviation of total rotational velocity.

It should be noted that the scatter plot has an x-axis in units of standard deviation (St. dev) of total acceleration (Acc), and the y-axis is in units of standard deviation of rotational velocity (gyro). The scatter plot may be constructed using a log scale.

The classification boundary 50 may be constructed manually using training data or using a machine learning model, e.g. an unsupervised machine learning model such as a clustering algorithm, e.g. k-means clustering. At inference time, if an event falls within the classification boundary, it is classified as a blade-on/connection event, or a blade-off/disconnection event. If an event falls outside the classification boundary, it is classified as another event, or a non-connection/non-disconnection event. Such other events may include operating the apparatus to perform the function associated with the device, e.g. shaving, trimming, cutting, etc.

With reference to FIGS. 10A and 10B, in other embodiments, the posts 22 may comprise a first protrusion 54 and a second protrusion 56 separated from the first protrusion by a notch 58. The notch 58 provides a weak point for the second protrusion to beak off in response to disconnecting the device from the connection portion, i.e. in response to a disconnection event. In this way, a vibration pattern of the spring passing over the protrusion(s) is different for a new blade and a used blade. In this way, a signal can be output by the controller to warn a user they are using a worn blade.

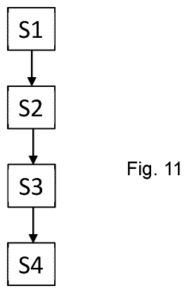

With reference to FIG. 11, the foregoing embodiments can be summarised as a computer-implemented method of detecting a connection event in response to connecting a device to a connection portion of a head of a personal care apparatus, or detecting a disconnection event in response to disconnecting the device from the connection portion of the head of the personal care apparatus. The computer-implemented method may comprise: monitoring (S1) measurements from an inertial measurement unit, IMU, sensor over time, the IMU sensor positioned within a handle of the personal care apparatus, the head at an end of the handle; computing (S2) one or more measurement values from the monitored measurements; identifying (S3) a connection event or a disconnection event when the one or more measurement values fall within a classification boundary; and outputting (S4) the identified connection event or disconnection event as a signal.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. Any reference signs in the claims should not be construed as limiting the scope.

1. A personal care apparatus (10) comprising:
a handle (12);
a head (14) at an end of the handle and having a connection portion (16) for a device (18) to connect to and disconnect from;
an inertial measurement unit, IMU, sensor (40) within the handle (12); and
a controller (42) configured to:
monitor measurements from the IMU sensor (40) over time;
compute one or more measurement values from the monitored measurements;
identify a connection event or a disconnection event when the one or more measurement values fall within a classification boundary (50); and
output the identified connection event or disconnection event as a signal,
wherein the IMU comprises an accelerometer for measuring acceleration and a gyro for rotational velocity.

2. The personal care apparatus (10) of claim 1, wherein the controller (42), when monitoring measurements from the IMU sensor (40) over time, is configured to monitor acceleration and angular velocity from the IMU sensor (40) in x, y, and z, axes, wherein optionally the x axis is a longitudinal axis of the body, and y and z axes are orthogonal to the x axis.

3. The personal care apparatus (10) of claim 2, wherein the one or more measurement values includes a total acceleration and a total angular velocity, wherein the controller (42) is configured to, when computing the one or more measurement values, calculate the total acceleration using the formula,
$${a}_{T} = \sqrt{{a}_{x}^{2} + {a}_{y}^{2} + {a}_{z}^{2}}$$
and calculate the total rotation velocity using the formula
$${g}_{T} = \sqrt{{g}_{x}^{2} + {g}_{y}^{2} + {g}_{z}^{2}} ,$$
where a_{T} is the total acceleration, aₓ is an acceleration in the x-axis, a_{y} is an acceleration in the y-axis, a_{z} is an acceleration in the z-axis, g_{T} is the total rotational velocity, gₓ is a rotational velocity in the x-axis, g_{y} is a rotational velocity in the y-axis, and g_{z} is a rotational velocity in the z-axis.

4. The personal care apparatus (10) of claim 3, wherein the controller (42) is configured to, when, identifying the connection event or the disconnection event when the one or more measurement values fall within the classification boundary (50), plot a standard deviation of the total acceleration and a standard deviation of the total rotational velocity on a scatter plot having one axis corresponding to standard deviation of total acceleration and another axis corresponding to standard deviation of total rotational velocity.

5. The personal care apparatus (10) of claim 1, wherein the controller (42) is configured to, when monitoring measurements from the IMU sensor (40) over time, construct a waveform from the measurements of the IMU sensor (40) over time.

6. The personal care apparatus (10) of claim 1, further comprising a motor for powering the device (18), wherein the controller (42) is configured to operate in a standby mode when the motor is not running.

7. The personal care apparatus (10) of claim 1, wherein the connection portion (16) is configured to deform in response to a connection formation of the device (18) being inserted into it, the deformation being detectable by the IMU sensor (40).

8. The personal care apparatus (10) of claim 7, wherein the connection portion includes a spring (26) and the connection formation includes a protrusion (28; 54), wherein the spring (26) is configured to deform by compressing in response to the protrusion (28; 54) moving past the spring (26) and to revert to its neutral position in response to the protrusion (28; 54) having moved past the spring (26), wherein the IMU sensor (40) is configured to detect the spring (26) reverting to its neutral position.

9. The personal care apparatus (10) of claim 8, wherein the protrusion is a first protrusion (54) and the connection formation includes a second protrusion (56) separated from the first protrusion (54) by a notch (58), wherein the notch (58) provides a weak point for the second protrusion (56) to break off in response to disconnecting the device (18) from the connection portion.

10. The personal care apparatus (10) of claim 1, further comprising the device (18).

11. The personal care apparatus (10) of claim 1, wherein the personal care apparatus (10) is a shaver and the device (18) comprises a blade.

12. A computer-implemented method of detecting a connection event in response to connecting a device (18) to a connection portion (16) of a head (14) of a personal care apparatus (10), or detecting a disconnection event in response to disconnecting the device (18) from the connection portion (16) of the head (14) of the personal care apparatus (10), the computer-implemented method comprising:
monitoring (S1) measurements from an inertial measurement unit, IMU, sensor (40) over time, the IMU sensor (40) positioned within a handle (12) of the personal care apparatus (10), the head (14) at an end of the handle (12);
computing (S2) one or more measurement values from the monitored measurements;
identifying (S3) a connection event or a disconnection event when the one or more measurement values fall within a classification boundary (50); and
outputting (S4) the identified connection event or disconnection event as a signal,
wherein the IMU comprises an accelerometer for measuring acceleration and a gyro for rotational velocity.

13. A transitory, or non-transitory, computer-readable medium, having instructions stored thereon that, when executed by a processor (46), cause the processor (46) to perform the computer-implemented method of claim 12.
